(19) United States
(12) Patent Application Publication
(10) Pub. No.: US 2011/0225241 A1
(43) Pub. Date: Sep. 15, 2011

(54) SOCIAL WRITING APPLICATION PLATFORM

(75) Inventors: William Hart-Davidson, Williamston, MI (US); Jeffrey Grabill, Okemos, MI (US); Michael McLeod, Haslett, MI (US)

(73) Assignee: BOARD OF TRUSTEES OF MICHIGAN STATE UNIVERSITY, EAST LANSING, MI (US)

(21) Appl. No.: 13/045,644

(22) Filed: Mar. 11, 2011

Related U.S. Application Data
(60) Provisional application No. 61/313,106, filed on Mar. 11, 2010.

(51) Int. Cl. G06F 15/16

(52) U.S. Cl. 709/204

(57) ABSTRACT

Methods and systems for tracking and evaluating social writing activities are discussed. In one example embodiment, a method for tracking and evaluating social writing activities includes operations for monitoring content creation, tracking social behaviors, identifying activities of value, and associating the activities of value with a complex activity. The monitoring content creation can include detecting activities within a social software environment. The tracking social behaviors include tracking behaviors related to the content creation activities performed within the social software environment. The identifying activities of value include identifying activities of value associated with the content creation activities. Finally, associating the activities of value with a complex activity can form a composite picture.

This application claims the benefit of priority under 35 U.S.C. 119(e) to U.S. Provisional Patent Application Ser. No. 61/313,106, filed on Mar. 11, 2010, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2009, Michigan State University. All Rights Reserved.

### TECHNICAL FIELD

Various embodiments relate generally to the field of data processing, and in particular, but not by way of limitation, to systems and methods associated with a social writing application platform.

### BACKGROUND

The use of social networking and collaboration software is exploding with the rapid expansion and acceptance of Web. 2.0 within social and commercial applications.

### BRIEF DESCRIPTION OF THE DRAWINGS

Some embodiments are illustrated by way of example and not limitation in the figures of the accompanying drawings in which:

FIG. 1 is a block diagram that depicts an example social writing application platform.

FIG. 2 is a block diagram depicting an example system including a social writing application platform, according to an example embodiment.

FIG. 3 is a block diagram depicting an example system including a social writing application platform, according to an example embodiment.

FIG. 4 is a block diagram depicting an example system including a social writing application platform, according to an example embodiment.

FIG. 5 is an illustration depicting graphical examples demonstrating an example difference between content management systems and a social writing application platform, according to an example embodiment.

FIG. 6 is a block diagram depicting an example of a typical content management database in comparison with an example social writing application platform database.

FIG. 7 is a block diagram depicting examples of data objects that can be associated with any other type of object within a social writing application platform, according to an example embodiment.

FIGS. 8-10 are illustrations of example output from a social writing application platform enabled system, according to an example embodiment.

FIG. 11 is an example user-interface screen for a content management system enabled with the social writing application platform.

FIG. 12 is an example user-interface screen for a business writing system enabled with the social writing application platform.

FIG. 13 is an example user-interface screen for a social writing system enabled with the social writing application platform.

FIG. 14 is a block diagram of a machine in the example form of a computer system within which instructions for causing the machine to perform any one or more of the methodologies discussed herein may be executed.

### DETAILED DESCRIPTION

Disclosed herein are various embodiments (e.g., examples) of the present invention for providing a social writing application platform. Business and technical writing, in particular, is a collaborative, social activity with numerous people submitting contributions, making comments and suggestions and performing editing. Software that supports collaborative writing is popular because it enables social behaviors that provide value to teams and organizations. However, in such an environment it is often hard to know who participated in creating the final product and to assess the value generated by user participation.

The Social Writing Application Platform (SWAP) includes a set of analytical tools that can be coupled with common social writing software functions to help users and organizations to better understand social behaviors involved in writing tasks. SWAP can track specific user activities and provide analytic tools to make the collected data accessible and useful. SWAP can pay attention to activities of value, such as people working on the same documents, ideas, or as part of the same groups. SWAP can track and record detailed interactions by multiple contributors in the creation of a document or other creative work.

SWAP can make analytical information about the writing process accessible, provide feedback to individual users, and store measurement and tracking information related to the social writing process. Additional details on each of these capabilities include:

Assessable analytics: Makes sense of complex knowledge work in terms that are easily understood. It helps to create an understanding of how people build, edit, revise, comment on, share, use, reuse and rate objects.

Feedback to users: Provides views of knowledge work that are useful to the knowledge workers themselves, not just researchers, managers, or analysts.

Tracking and measurement: Social behavior such as sharing, co-creating content, and being able to find resources such as people and information can be tracked.

SWAP is an integrated set of analytic tools that can be incorporated into social software (e.g., content management tools, social networks, online collaboration, etc . . . ) to help users, administrators and researchers track, measure and understand the creative process. It can be used by a variety of Internet-based social software, including the following:
Commercial, business-oriented collaborative software such as Microsoft SharePoint and Lotus Domino
Social websites such as Facebook and MySpace
Software used for writing courses and games

The SWAP looks at writing for an organization and from the perspective of the organization. It provides analytic tools that can be added to a content management system to give a coherent picture of the writing-related activity. SWAP is the analytic layer—not the production layer.

At its core, SWAP includes a set of reusable software components that could be thought of as a toolkit for adding the SWAP analytics functions to social- or collaborative-oriented web sites that support writing as a social activity by providing functions for creating, sharing, and reviewing text.

To integrate the SWAP components into a software product or service, hooks would be added to the existing software to capture whenever a user takes an action. These hooks would be used to populate SWAP databases, which can then be analyzed by the SWAP analytics components. User interface integration would not be required other than by the addition of links to the SWAP pages. Different SWAP pages could be provided for users and for administrators.

SWAP includes a set of analytical tools coupled with common social software functionality that enables tracking and measuring social behavior in digital environments in new ways. In these environments, social behaviors are written behaviors quite literally visible in written artifacts or as written traces within the system. SWAP pays attention to what nearly everyone else ignores-the traces that are left behind by very specific user activities in social software environments. SWAP reclaims the data made available in digital spaces by user social activity and makes that data accessible, visible, and useful.

SW AP and its analytic capabilities provide a powerful means to identify and trace social behaviors and to assess value generated by user participation in social software.

For writing researchers, writing is the most important indicator for understanding digitally mediated knowledge work. However, writing is not a focal point for most people in the context of their everyday work and therefore most writing software fails to adequately account for the details of writing behavior. Instead, writing is the means to a variety of social ends.

SWAP understands writing activity to be an index of social behavior in the way that writing researchers do. But, it also understands that writing activity, however rich with indicators of group and individual development, is not what users are most interested in seeing. So, we analyze the results of that activity and feed it back in ways that are useful.

SWAP allows people to make sense of complex knowledge work in terms they understand. Because knowledge work is so information rich and therefore communication intensive, we tend to see work itself, as one of our colleagues has written “as a series of . . . exchanges, our empirical studies of communication-particularly at the micro level-tend to focus on chains of communicative events in which people exchange artifacts in a regular series and synthesize them in relatively predictable ways.” This description of knowledge work as a set of regular information exchanges is also a pretty good description of what users do in social software environments-exchange artifacts (like pictures) in regularized ways and make new things with them in predictable ways (the predictability sometimes a function of what the software permits users to do). And so studies of writing as knowledge work (or knowledge work as writing) have provided examinations of tax documents as a way to understand auditing work, the genres used to support team formation and collaborative work, the activity system of a patent office, and much, much more.

SWAP takes this analytic approach a step further by providing views of knowledge work that are useful to the knowledge workers themselves and not only writing researchers.

### Example Platform

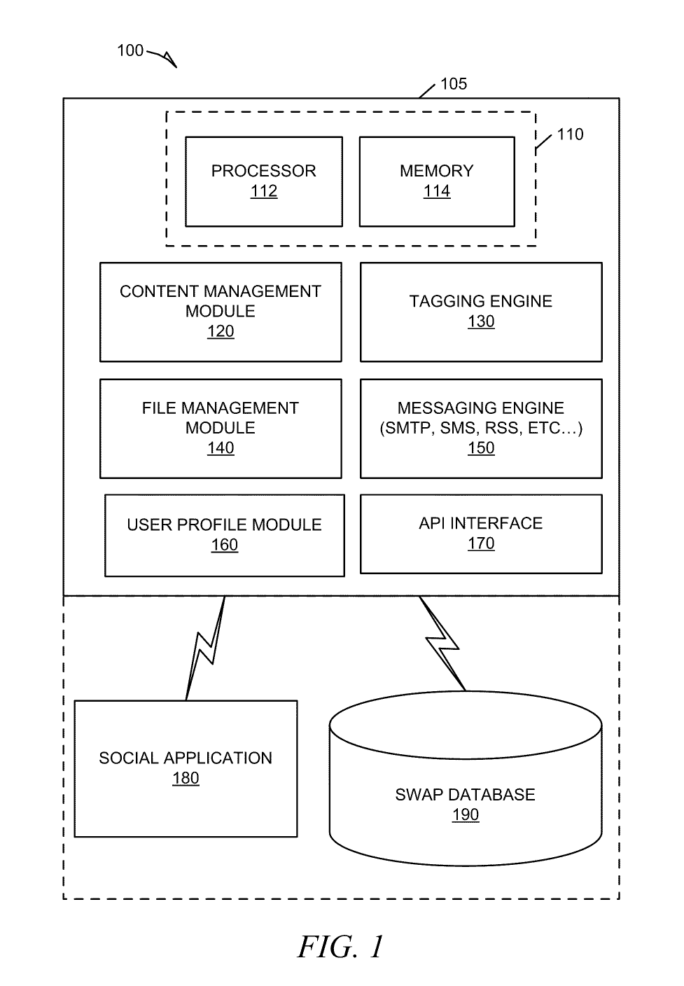

FIG. 1 is a block diagram that depicts an example social writing application platform. The social writing application platform (SWAP) system 100 can include a server 105, a social application 180, and a SWAP database 190. The server 105 can include a processing module 110, which can include a processor 112 and a memory device 114. The server 105 can also include a content management module 120, a tagging engine 130, a file management module 140, a messaging engine 150, a user profile module 160, and an application programming interface (API) 170. In certain examples, the server 105, social application 180, and the SWAP database can be incorporated into one computer system.

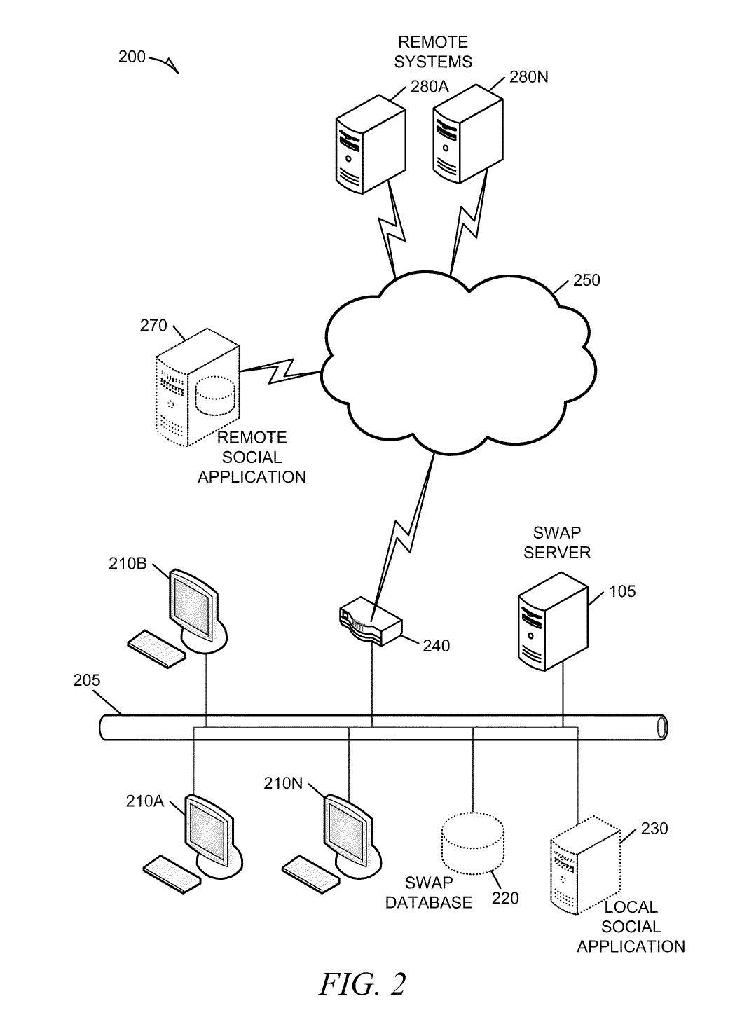

FIG. 2 is a block diagram depicting an example system 200 including a social writing application platform, according to an example embodiment. The system 200 depicts potential configurations for deployment of a SWAP platform. In an example, the system 200 can include a local-area network 205, SWAP server 105, local clients 210A-N (referred to collectively as local client 210), SWAP database 220, local social application 230, gateway 240, wide-area network 250, remote social application 270, and remote systems 280A-N (collectively referred to as remote system 280). In this example, the SWAP server 105 can interface with both the local social application 230 and the remote social application 270 to monitor and track content creation activities. Clients can access the local social application 230, the remote social application 270, and the SWAP server 105 through local clients 210 and remote systems 280.

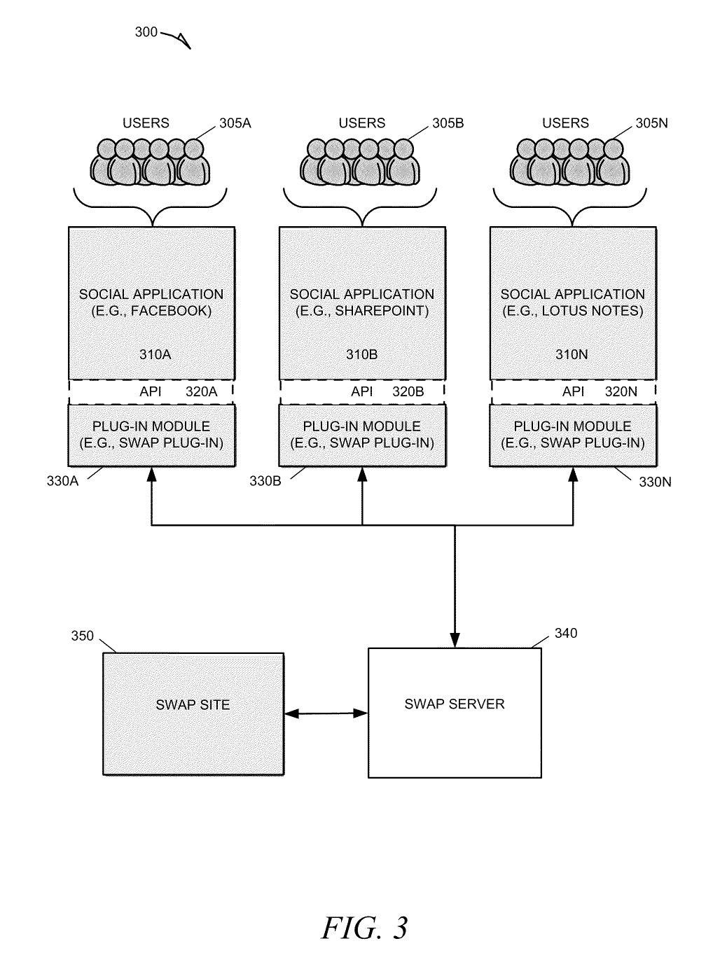

FIG. 3 is a block diagram depicting an example system 300 including a social writing application platform 340, according to an example embodiment. In this example, the system 300 can include multiple social applications 310A-N, including social networking application such as FACEBOOK™, SHAREPOINT™, or LOTUS NOTES™, to name a few. The system 300 can also include a SWAP server 340, which can host a SWAP site 350 to provide end-users an interface into information collected on the SWAP server 340. In an example, the SWAP server can access the social applications 310 via a plug-in module 330, such as plug-in module 330A for accessing the FACEBOOK™ social network. In certain examples, the plug-in modules 330 interface with the social applications 310 via an API 320.

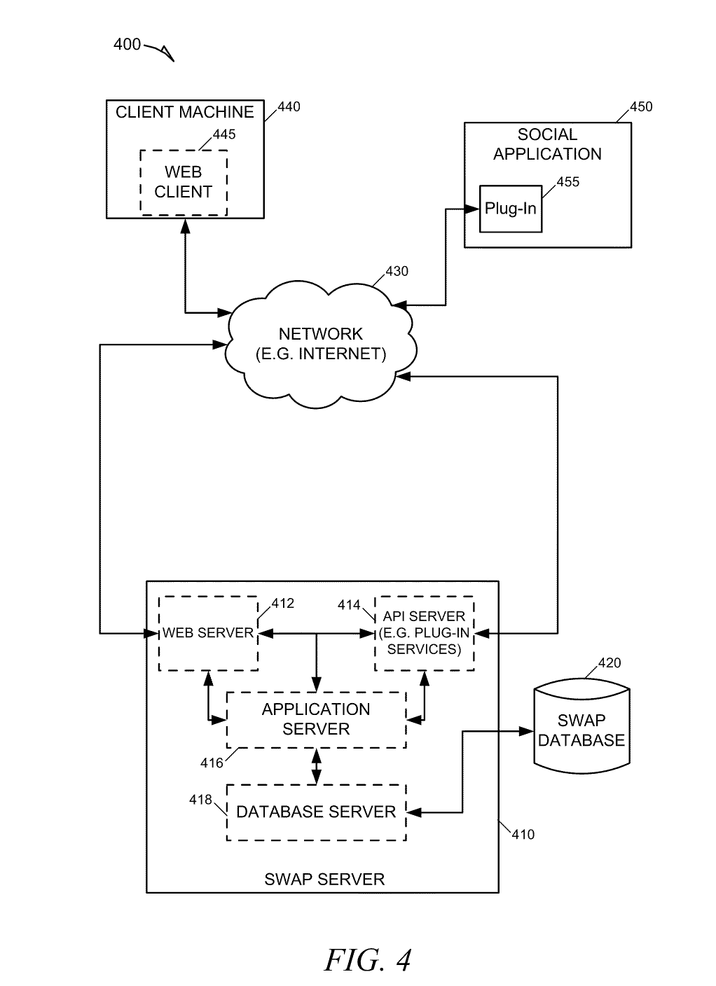

FIG. 4 is a block diagram depicting an example system 400 including a social writing application platform 410, according to an example embodiment. In an example, the system 400 can include a SWAP server 410, a SWAP database 420, a network 430, a client machine 440, and a social application 450. In this example, the client machine 440 can include a web client 445 to enable communication over the network 430 with the social application 450 ad the SWAP server 410. In this example, the social application 450 can include a plug-in 455 to enable communication with and monitoring by the SWAP server 410.

In an example, the SWAP server 410 can include a web server 412, an API server 414, an application server 416, and a database server 418. The web server 412 can be configured to provide a web interface to the SWAP server 410. The web server 412 can communicate with the API server 414 and the application server 416 to deliver content to the client machine 440 over the network 430. In an example, the application server 416 provides the primary functionality discussed below.

### SWAP Analytics—Making Social Activity Accessible, Visible, and Useful

Social software has captured the attention of organizations and users because social software enables behaviors that can translate into value for individuals, teams, and organizations. SWAP analytics can provide an elegant and powerful way to identify and trace social behaviors in technological environments in order to assess, for the first time, value generated by the use of social software environments. SWAP provides these capabilities by identifying social behaviors and tracing them as they are bundled into outcomes determined to be valuable: knowledge, products (e.g., proposals), or teams.

SWAP stands for Social Writing Application Platform, and SWAP includes a suite of social software functions that are common to many other software environments. One value of SWAP includes its analytical power, capabilities that can be built into other software tools and environments.

The following is an example way to understand what is meant by “social behaviors” in software environments, how SWAP operationalizes them in order to make them visible, and how SWAP pays attention to those visible traces. The following describes an example scenario of use applicable to application of an example implementation of SWAP:

The scene is a mature research corporation that focuses on applying basic research to technological challenges in space, including the development of satellites, sensors, and reconnaissance data visualization hardware. This organization both produces basic research and coordinates the research findings of partner organizations. It also has units that work on translating that research into applications.

We focus on Megan, who is a proposal writing manager within that organization. As such, she plays a central role in the financial stability of her organization. Supervising a team of communication specialists as well as serving as the coordinator with the organization's research scientists and engineers, Megan's professional life is devoted to proposal development work.

We know that proposals are valuable products in this organization. Successful proposals are a primary funding stream for the organization, but they are also representations of the strategic partnerships required to produce products. Anecdotally, we know that the work of producing a proposal is distributed across a number of individuals, teams, and organizations (as well as time and space). But it would be nice to know which people and tools (e.g., documents or information) facilitate proposals and which activities (social behaviors) produce desired outcomes—which ones add value? While such information would be useful, any effort to gather this information must confront how to identify it given that much of this activity takes places using social software tools.

SWAP is designed to solve the problems identified in this very real example, among other things. Social software exists to facilitate behaviors that are clearly social in nature but that also facilitate certain kinds of work. In an educational setting, we might understand this work as “learning.” In a lab setting, we might understand it as “research.” In a particular kind of corporate setting, we might understand the work as “auditing.” Across these settings, there are certain behaviors that are commonly facilitated by social software—activities such as finding, sharing, and making We use social software because these behaviors are made easier and more valuable to us. Or so we hope. When certain kinds of social behaviors are valuable, such as sharing, co-creating content, or being able to find resources (both information and people), it is not only important to facilitate those behaviors but to track them and measure them.

With SWAP, a tool is provided to understand social behavior in digital environments in new ways. This is the first and most important advantage of SWAP analytics, although many additional advantages will be evident from the description of SWAP. SWAP generally operates within a pradigm that includes social software environments and within social software environments, social behaviors are written behaviors. The social behaviors are quite literally visible in written artifacts or as written traces within the system.

The power of SWAP is that it pays attention to what others ignore—the traces that are left behind by very specific user activities in social software environments.

Standard social software systems don't pay attention to the actions of writing in this way. Standard social software systems include databases, which leave valuable records either uncaptured or scattered and unusable. SWAP reclaims the descriptive power of data that is produced by writing in a digital environment. SWAP can, but doesn't necessarily create new data, SWAP can make available data usable and useful.

### SWAP Reclaims Data Made Available in Digital Spaces by User Social Activity and Makes the Data Accessible, Visible, and Useful:

How? The most direct answer is that SWAP pays attention to data streams that other analytics don't pay attention to. SWAP filters out operational detail that tends not to matter to users but often matters to systems. SWAP pays attention to activities of value, such as people working on the same documents, ideas, or as part of the same groups. These behaviors leave traces in the system that we aggregate and make visible to users (and to researchers watching the social activity in the system).

In some examples, the focus of SWAP analytics is not in the creation of new data types or tools. In these examples, SWAP focuses on making sense of and deriving value from online social behavior.

### Technical Description of SWAP:

As a full platform of functions, SWAP can do a number of things. SWAP's core architecture includes:
a fully relational object database that stores user-contributed content
a user profile system that enables social networking
a folksonomic (tagging) system that facilitates user-generated organizational categories and metadata
faceted browsing and recommender functions that allow users' activities, interests, ratings etc. to influence what they see
file management functions (upload, sort, full-text search)
content management functions (collaborative authoring/wiki, versioning, rolebased permissions and workflows)
mapping (via Google maps API)
feeds (RSS)
mail & messaging (c.g. SMS)
custom document markup

Much of this functionality is shared with many other software tools. While this core architecture is relevant to the analytical capabilities of SWAP, the most salient technical issue is the ability of SWAP to work in any open social framework and with a number of server and database technologies.

An example implementation of SWAP is built on mysql database technology. The prototypes we have built for specific projects (because that is all there is) are built using PHP as the server technology and mysql for database storage. Complex user interfaces are built using AJAX. All code (xhtmllcss/javascript) is compliant with WC3 standards.

In an example implementation, the code is stored using Subversion version management software, which means that we are able to track changes, view development histories, and facilitates documentation of code. The JavaScript and PHP code is thoroughly commented for easier development integration. In an example implementation, SWAP can interface with open social, facebook connect, or openid services.

### SWAP Analytics

Most content management and learning management systems offer little to no differentiation between types of objects—most, after all, are designed to create web pages and nothing else. Or, to be more precise, for most of these systems, “the page” is the most important unit of analysis and, therefore, what analytics attend to. SWAP moves away from a focus on the page and toward a focus on objects. Within an example implementation of SWAP, “objects” can refer to things in a social system that become the nodes to which people gravitate and link.

Without powerful objects (nodes) there is no social network.

As online marketers like to say, the most important activity on the internet is not “search.” It is “share.” Sharing is the core of social behavior online, and what is shared are objects: texts, products, ideas, pictures, groups, videos, people, ourselves. Objects are the center of gravity for exchanges, transactions, and other forms of work.

To understand social behaviors in online systems, it is necessary to understand more than what is going on with objects like “pages.” The understanding needs to be more granular, throughout all levels of objects. Therefore, SWAP can see and trace object-centered behaviors. In a typical content management system, documents and their edit histories are stored as records in a database. These systems are excellent at keeping track of the things people make. For making sense of social behaviors, the system needs to know two things in addition to what people make: the system needs to know how people build, edit, revise, comment on, share, use, reuse, and rate objects. And the system also needs to be able to differentiate between and among the various objects (including people) that exist and that interact within a given system. SWAP understands the differences between different kinds of objects and recognizes the boundaries of different object types. This allows SWAP to gather much more information about each type of object, including how it is created, how it is used, and how it leads to derivative works.

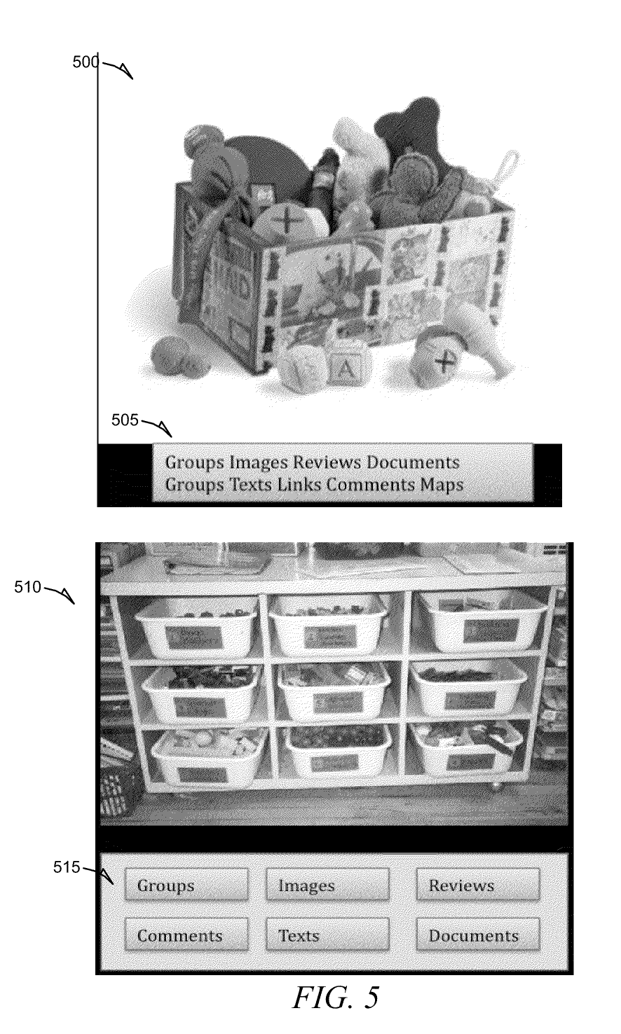

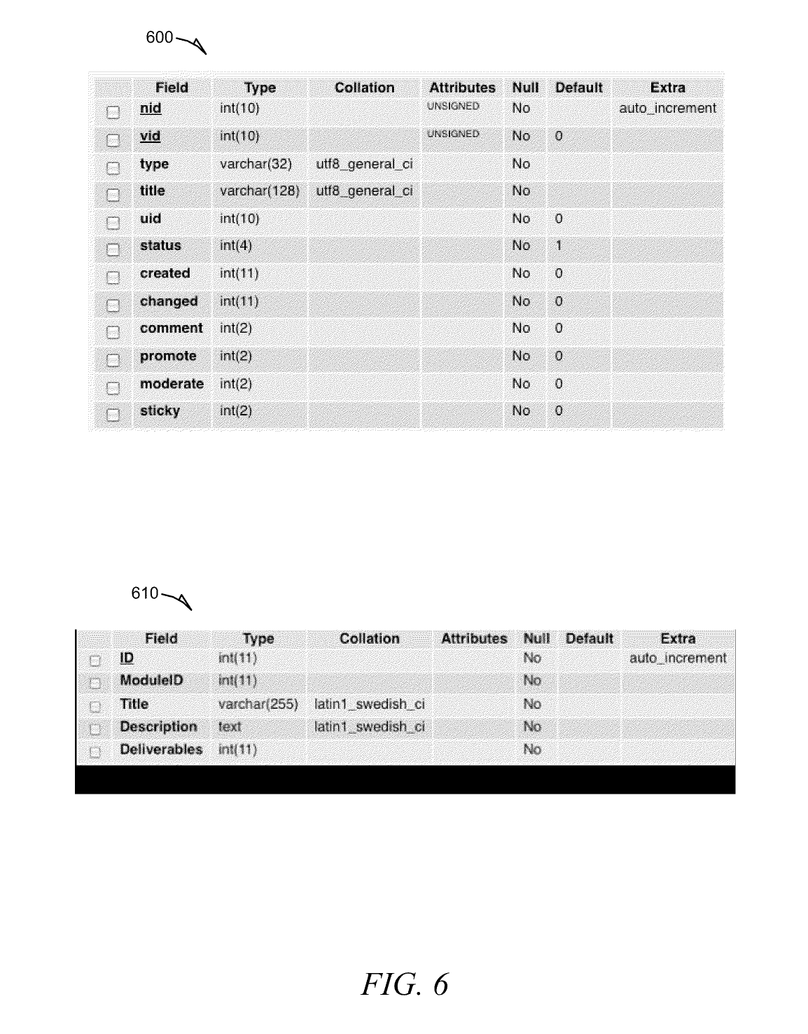

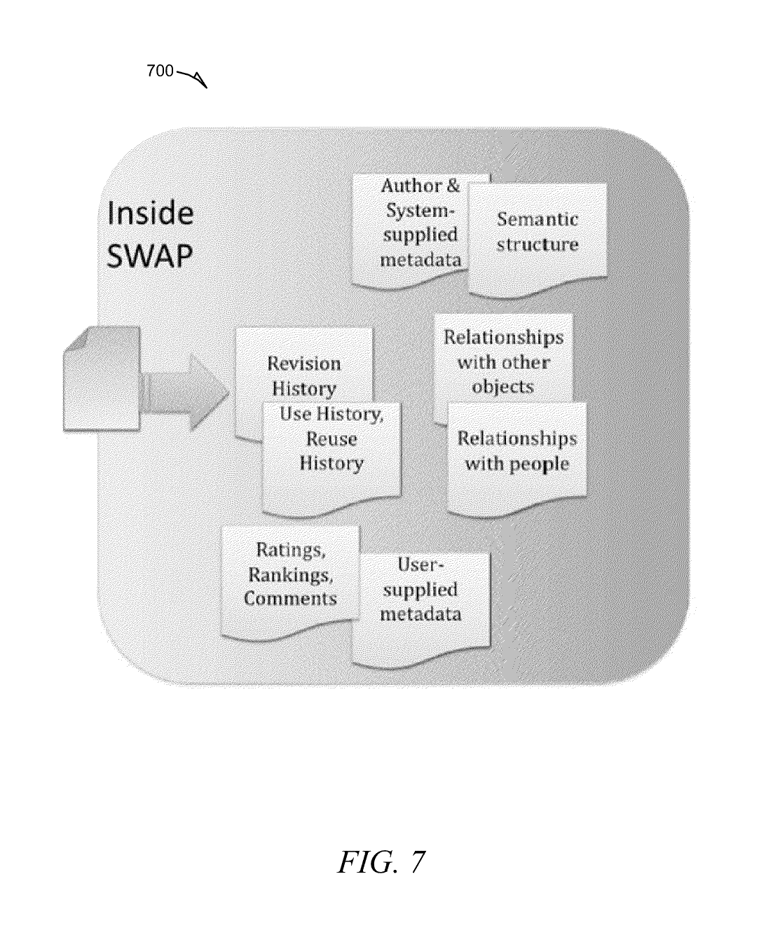

For example, most content and learning management systems store various objects in one big container; much like toys in a toy box (see FIG. 5, 500). Because all of the objects go together as part of web pages, this makes a great deal of sense and is, in fact, the most efficient way to store data. This approach is referred to as the toy box approach, and it is represented metaphorically in FIG. 5 by item 500 and by way of a real database example in FIG. 6, database table 600.

However, as shown in FIG. 5, 510, 515, the SWAP toy box is different. SWAP can understand objects and their boundaries while remaining flexible enough to see beyond those boundaries. Therefore, we organize our databases somewhat differently in order to see object boundaries more clearly and to allow us to search across object boundaries with more precision. For instance, a search for “pizza,” for example, would return any object containing that keyword, or that users had tagged as being related to “pizza,” not just webpages in which the “pizza” has been found.

FIG. 6, database table 600, as mentioned above, is an example of a typical database in a content management system. Here all content gets turned into a node. A node can be anything—a webpage, a file, a group. All of the information about these objects is placed into the same data structure.

As has been mentioned, the differences and boundaries between objects matters a great deal to SWAP analytics. And so, in FIG. 6, database table 610, depicts an example SWAP data structure. FIG. 6, database table 610 demonstrates how the SWAP datastructure differ from those of a typical node structure. In an example, the SWAP databases are designed with one fundamental rule—always keep things separate. Objects of different types are stored in different tables (though they may be assembled in the same page in a web interface). For instance, in this case (FIG. 6, 610), it is important that “assignments” remain separate objects from the “deliverables” that students make to meet the requirements of the assignment. This is true because an example implementation of SWAP supports a large number of content types, each of which requires specific information to be collected depending on the type—information on what objects people are making, how they are making these objects, and how they are sharing and associating these objects. These objects (“assignments” and “deliverables” in this case) are too complex, and our needs too specific, for a single data structure. In order to provide the discussed functionality, it can be argued that all objects in a viable social network are too complex for a single data structure.

Following the example “one object, one database table” approach allows context-appropriate data to be collected for each type, but more generally it allows SWAP to maintain object boundaries regardless of what people do to or with the objects. This, in turn, allows SWAP to make them visible and accessible as a matter of analytics and therefore useful in terms of the value that can be derived from seeing and understanding online social behaviors in new ways.

### What is the SWAP Different for Users?

In an example, SWAP's unique analytic approach for users can include that they get to see and understand their writing in terms they can understand. This means that instead of seeing lists of unconnected documents, for example, the user sees “activities” in which these documents (and other communicative objects) were implicated. Users can, in many cases, understand these activities in terms of specific projects the users are working on as well.

Users can also see things that are nearly impossible to see any other way: how specific documents and/or acts of writing influence the work of a whole group later on.

### Seeing Activities

For example, when studing grant writing teams, a very complex set of writing activities emerge over the course of a project. Grant writing teams write planning documents, create timelines and calendars, draft need statements, write letters and e-mail to solicit support from partnes. And, yes, grant writing teams also write grant proposals. But even those proposals are complex, often consisting of multiple pieces of writing: project descriptions, budgets, capacity statements, participant C.V.'s, etc.

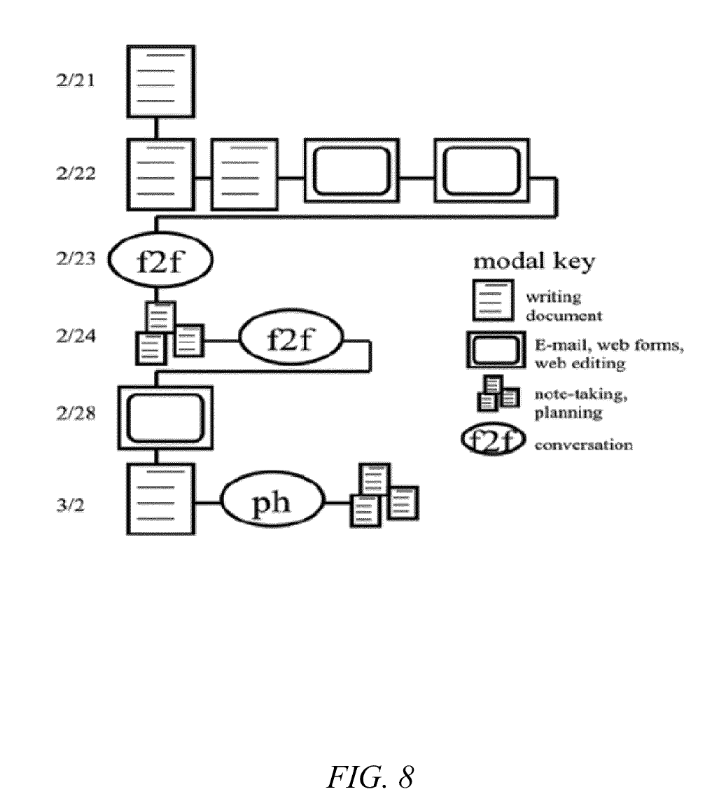

All of these acts of writing and all of the texts that result are meaningfully related to one another. Doing all of them is what it means to do “grant writing.” But in most writing environments, the relationships among these acts and texts never exist in the system's data structures. SWAP analytics captures these relationships and used them to give valuable feedback to users. One thing SWAP can do, then, that other systems cannot do is produce pictures of “grant writing” and other similar activities (see FIG. 8).

FIG. 8 shows communication events associated with grant writing for a specific user—Dave—over the course of one week. FIG. 8 shows written and oral events, for which there is some artifact or record in the system (e.g., that SWAP can collect and index within a database). The composite picture (FIG. 8) shows how these events unfolded over time for Dave—they are an index of his grant-writing activity. The data collected can be sorted in other terms too.

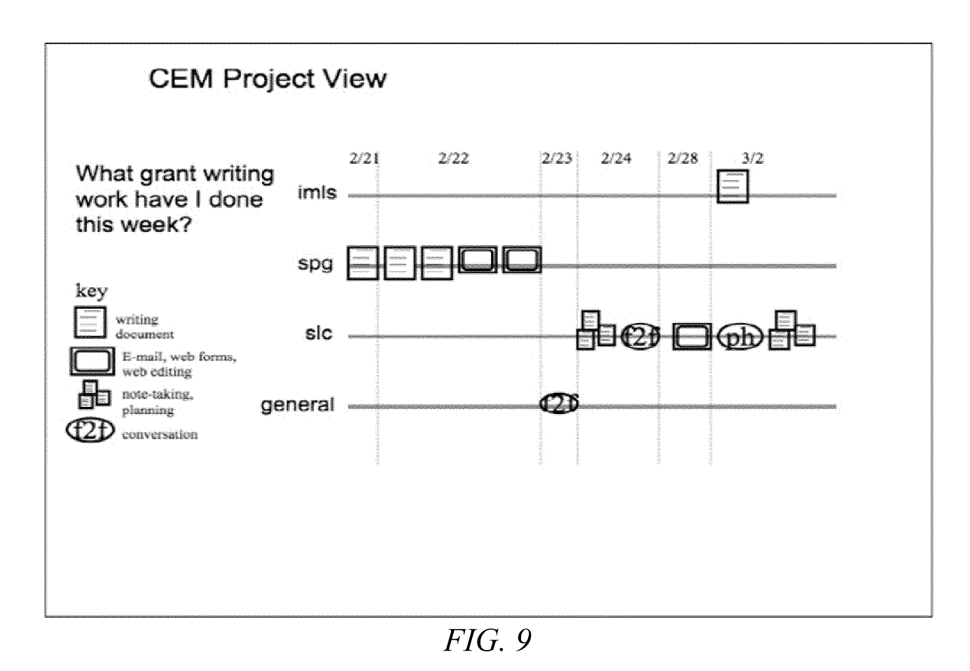

FIG. 9 presents the same data in a slightly different format, this time, with an added data point: project label. The system, SWAP, can also change the visualization format, as shown in FIG. 9. But, importantly, the data used to make the FIG. 9 is the same as that used to make FIG. 8.

In FIG. 9, the user, Dave, can see how his grant writing work breaks down by project (e.g., imis, spg, slc, general). The user can find things associated with a specific project and also get an account of how he has spent his time and effort over the last week. All of this is made possible by paying attention to his writing activity.

### Seeing How a Text Influences Other Work:

When a text is successful, it has a tremendous amount of influence on future writers and future texts. The successful text (output) becomes a precedent for others to follow, a template or model, a source from which future writers draw content and structure. Trouble is, these precedents get established after a document has been written, and, often, after the document has circulated among its intended audience. Documents become valuable during moments of use “downstream” from their original context. SWAP allows us to trace these moments too, and to make users aware of how their writing—or someone else's—is being used by other members of their group.

How does SWAP do this? Writing researchers have known for a long time that where we can see regularities in the structure of a text, we are also seeing repeated behavior. People repeat what works for them. And one result of these repeated behaviors is a set of stable, predictable forms of writing that correspond to typical organizational needs and tasks.

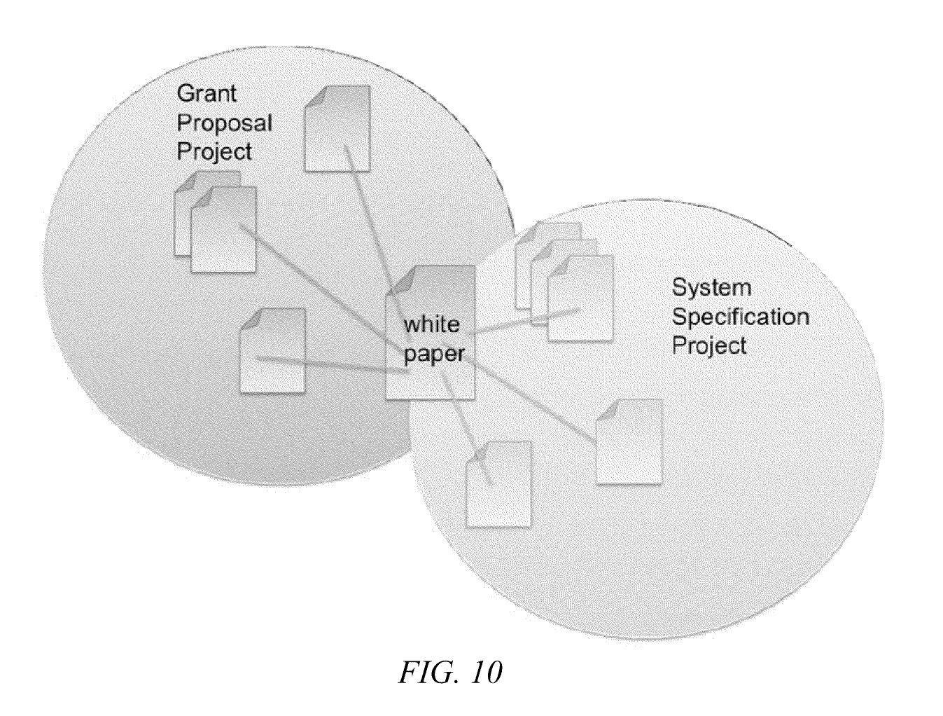

Writing researchers call these stable forms of writing “genres.” SWAP understands genres to be collections of textual forms that correspond to social actions. SWAP can use this understanding to enable users to see when a document they wrote is meaningful to another project, for example, even if it is a project they aren't working on. SWAP shows users pictures like that depicted by FIG. 10, for example:

### Social Writing Application Platform

Writing Indexes Social Behavior—Writing research produces rich accounts of texts and the people that make and use them; we can use these accounts to produce pictures of activity that is otherwise invisible.

Writing Scaffolds Social Learning—Accounts of writing activity can be the means by which non-researchers understand, act upon and improve their work.

Documents are Interfaces—Not merely fossilized records of activity in the past, or communicative artifacts instantiating a dialogic present, texts of all sorts are also sites of both anticipated and unanticipated action in the future.

Analyzing Social Writing—SWAP provides the means to analyze writing activity and offer feedback to users.

SWAP pays attention to writing activity and constructs accounts of writing projects. This makes SWAP useful for coordinating the distributed work of writing.

SWAP is not a single application. SWAP is a set of data structures, design patterns, and algorithms that aggregate, analyze, and visualize writing activity.

### SWAP—Example Implementations

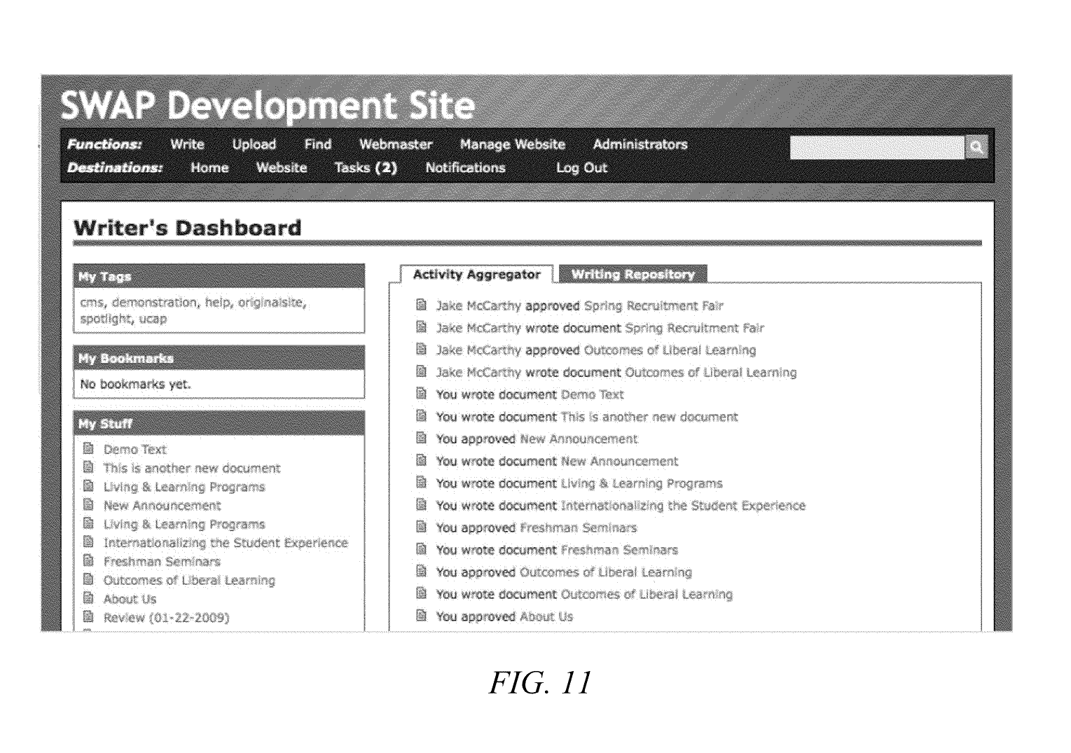

A Content Management System for Small Offices—FIG. 11

This SWAP-powered CMS can enable a small organization to distribute authorship and management of their website. FIG. 11 illustrates an example “dashboard” view. The dashboard gives users access to their materials and a summary of activity by their coworkers. For a group of people who struggle, under normal circumstances, to keep up with what's been going on with their website given that they all work on other things and work in many cases at different times, this one screen provides an answer to that problem.

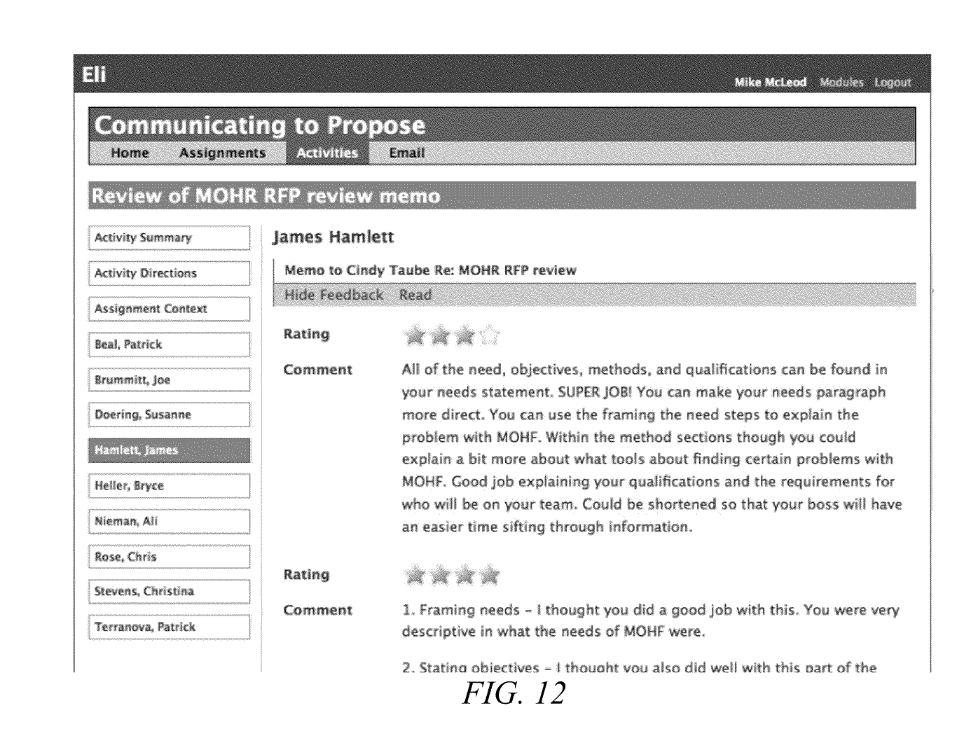

Business Writing Course Software—FIG. 12

FIG. 12 depicts a system, ELI, used to teach business communication modules. This view, which is a summary of an in-class activity, aggregates the results of peer review. The teacher can assign groups, and see the class average rating and textual comments for each group and each student. This allows the highest rated examples to be easily identified. We even calculate a “Best in Show.” Best of all, Eli does in about 15 minutes what used to take teachers a day or more to do.

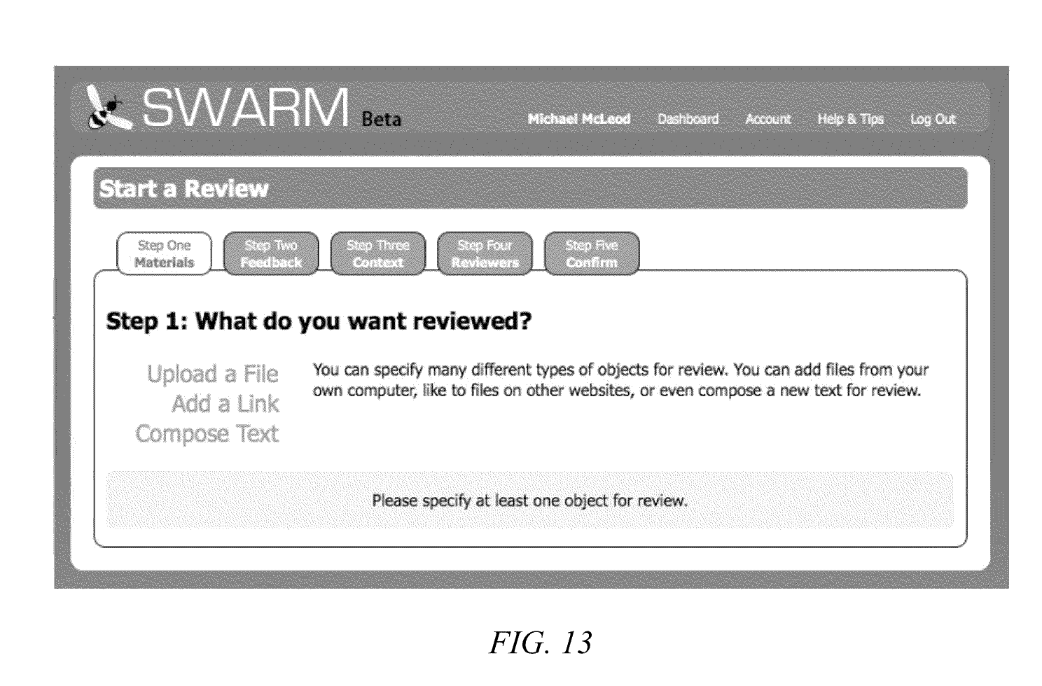

A Web Service for Writing Review—FIG. 13

Swarm is designed to coordinate writing reviews of any sort. It will not only help users manage the logistics of a review, it also allows them to quickly and easily view aggregated results from a review. Swarm uses an algorithm to calculate a reviewer's “helpfulness score” and a game-like badge to let them see how they are doing. This feature creates some formative, teachable moments for users who want to improve as reviewers.

### Modules, Components and Logic

Certain embodiments are described herein as including logic or a number of components, modules, engines, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a SaaS. For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of these. Example embodiments may be implemented using a computer program product (e.g., a computer program tangibly embodied in an information carrier, in a machine-readable medium for execution by, or to control the operation of, data processing apparatus, a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, for example, a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

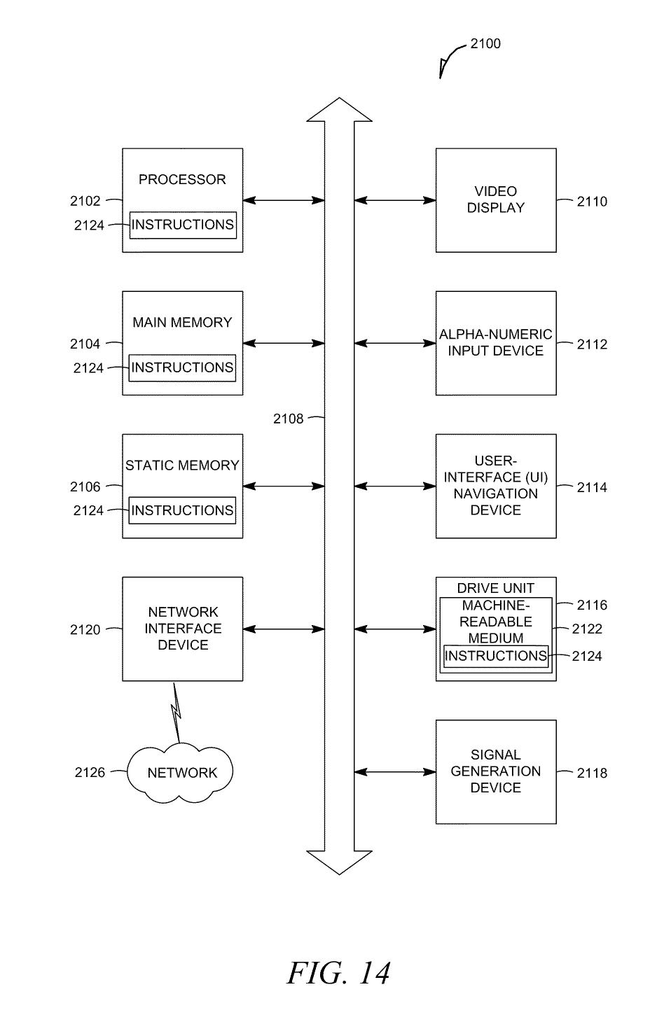

FIG. 14 is a block diagram of a machine in the example form of a computer system 2100 within which instructions for causing the machine to perform any one or more of the methodologies discussed herein may be executed. As such, the computer system 2100, in one embodiment, comprises the system 2100. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2100 includes a processor 2102 (e.g., a central processing unit (CPU), a graphics processing unit (GPU) or both), a main memory 2104, and a static memory 2106, which communicate with each other via a bus 2108. The computer system 2100 may further include a video display unit 2110 (e.g., a liquid crystal display (LCD) or a cathode ray tube (CRT)). The computer system 2100 also includes an alphanumeric input device 2112 (e.g., a keyboard), a user interface (UI) navigation device 2114 (e.g., a mouse), a disk drive unit 2116, a signal generation device 2118 (e.g., a speaker) and a network interface device 2120.

### Machine-Readable Medium

The disk drive unit 2116 includes a machine-readable medium 2122 on which is stored one or more sets of data structures and instructions (e.g., software) 2124 embodying or utilized by any one or more of the methodologies or functions described herein. The instructions 2124 may also reside, completely or at least partially, within the main memory 2104 and/or within the processor 2102 during execution thereof by the computer system 2100, with the main memory 2104 and the processor 2102 also constituting machine-readable media.

While the machine-readable medium 2122 is shown in an example embodiment to be a single medium, the term “machine-readable medium” may include a single medium or multiple media (e.g., a centralized or distributed database, and/or associated caches and servers) that store the one or more data structures and instructions 2124. The term “machine-readable medium” shall also be taken to include any tangible medium that is capable of storing, encoding or carrying instructions for execution by the machine and that cause the machine to perform any one or more of the methodologies of the present embodiments of the invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 2124 may further be transmitted or received over a communications network 2126 using a transmission medium. The instructions 2124 may be transmitted using the network interface device 2120 and any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for making contextual recommendations to users on a network-based marketplace have been described. Although the present embodiments of the invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, if used the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The claimed invention includes:

1. A method comprising:
monitoring content creation activities within a social software environment;
tracking social behaviors related to the content creation activities performed within the social software environment;
identifying activities of value associated with the content creation activities;
associating the activities of value with a complex activity to form a composite picture; and
providing an interface to present information related to the composite picture.

2. The method of claim 1, wherein tracking social behaviors includes identifying content reuse during the content creation activities.

3. The method of claim 1, wherein tracking social behaviors includes tracking one or more of the following behaviors associated with content creation:
locating information;
sharing information;
finding resources of information; and
generating information.

4. The method of claim 3, wherein tracking social behaviors includes extracting written artifacts associated with the social behaviors.

5. The method of claim 1, wherein monitoring content creation activities including monitoring activities on a social networking system.

6. The method of claim 1, wherein identifying activities of value includes analyzing individual contributions to the content creation activities in relation to an outcome associated with the complex activity.

7. The method of claim 1, wherein tracking social behaviors includes tracking revisions, comments, content reuse, and feedback received from a plurality of users during the monitored content creation activities.

8. The method of claim 1, wherein identifying activities of value includes capturing information about a user and a context of the user's content creation activity associated with an activity of value.

9. A system comprising:
a database configured to store information associated with content creation activities;
a server including a processor coupled to a memory device and communicatively coupled to the database, the server configured to,
monitor content creation activities within a social software environment,
track social behaviors related to the content creation activities performed within the social software environment,
identify activities of value associated with the content creation activities,
store the activities of value within the database,
associate the activities of value with a complex activity to form a composite picture, and
provide an interface to present information related to the composite picture to an end user.

10. The system of claim 9, wherein the server includes a folksonomic tagging system to generate user-generated organizational categories and metadata associated with the content creation activities.

11. The system of claim 9, wherein the server includes a user profile module that enables social networking functions.

12. The system of claim 9, wherein the server includes a content management module that enables collaborative authoring of content, version control, rolebased permissions, and workflow functions.

13. A tangible machine-readable storage medium containing instructions that when executed, on a machine, cause the machine to:
monitor content creation activities within a social software environment;
track social behaviors related to the content creation activities performed within the social software environment;
identify activities of value associated with the content creation activities;
associate the activities of value with a complex activity to form a composite picture; and
provide an interface to present information related to the composite picture.

14. The machine-readable medium of claim 13, wherein the instructions to track social behaviors further include instructions that when executed cause the machine to identify content reuse during the content creation activities.

15. The machine-readable medium of claim 13, wherein the instructions to track social behaviors include instructions that when executed cause the machine to track one or more of the following behaviors associated with content creation:
locating information;
sharing information;
finding resources of information; and
generating information.

16. The machine-readable medium of claim 15, wherein the instructions to track social behaviors include instructions that when executed cause the machine to extract written artifacts associated with the social behaviors.

17. The machine-readable medium of claim 13, wherein the instructions to monitor content creation activities include instructions that when executed cause the machine to monitor activities on an external social networking system.

18. The machine-readable medium of claim 13, wherein the instructions to identify activities of value include instructions that when executed cause the machine to analyze individual contributions to the content creation activities in relation to an outcome associated with the complex activity.

19. The machine-readable medium of claim 13, wherein the instructions to track social behaviors include instructions that when executed cause the machine to track revisions, comments, content reuse, and feedback received from a plurality of users during the monitored content creation activities.

20. The machine-readable medium of claim 13, wherein the instructions to identify activities of value include instructions that when executed cause the machine to capture information identifying a user and a context associated with the user's content creation activity associated with an activity of value.
